(19) United States
(12) Patent Application Publication
(10) Pub. No.: US 2008/0213520 A1
(43) Pub. Date: Sep. 4, 2008

(54) Multi-Layer Film With Triple Coextrusion Film

(75) Inventors: Buelent Tavsanli, Istanbul (TR); Afsin Dogan, Istanbul (TR); Andreas Grewe, Rheine (DE); Atilla Teoman Bostan, Istanbul (TR)

Correspondence Address: BOHAN MATHERS, PO BOX 17707, PORTLAND, ME, 04112-8707, US

(73) Assignee: Sunjuet Deuschland Gmbh, Rheine (DE)

(21) Appl. No.: 12/067,890

(22) PCT Filed: Jun. 8, 2006
(86) PCT No.: PCT/DE06/00989

§ 371 Date: Mar. 24, 2008

(30) Foreign Application Priority Data
Jun. 8, 2005 (DE) 10 2005 026 550.2
Jun. 29, 2005 (DE) 10 2005 030 163.0

(51) Int. Cl. B32B 1/00; B32B 9/04; B29C 65/00; B32B 7/02; B32B 15/04

(52) U.S. Cl. 428/35.2; 428/411.1; 428/34.1; 156/60; 428/332; 428/457; 428/212

(57) ABSTRACT

The invention relates to a multi-layer film with a deriving barrier layer and a plastic layer with reduced electrical resistance, whereby the plastic layer with reduced electrical resistance forms the middle layer of coextrusion film formed from three coextruded layers. The barrier layer is connected to the coextrusion film and on the side of the barrier layer facing away from the coextrusion film is provided with a plastic layer of limited extensibility.

### BACKGROUND INFORMATION

1. Field of the Invention

The invention relates to a multi-layer film having a dissipative barrier layer and a plastic layer with a reduced electrical resistance.

2. Description of the Prior Art

In the field of art, films having a dissipative barrier layer and a layer with reduced electrical resistance are known and are used, for example, as lining material for so-called “big bags.” The dissipative barrier layer should primarily provide reliable protection of a product, for example, against odors, air, and/or moisture and, secondly, make it possible to ground packaging made of the multi-layer film. The packaging may be constructed as a flexible container that serves in itself as a container or be used as the inliner of a “big bag”. The dissipative barrier layer may be produced as an aluminum layer, since aluminum ensures the desired barrier properties and is economical to process. In the following description, an aluminum layer is therefore always mentioned merely as an example that is also representative of other types of constructions of barrier layers.

The plastic layer with reduced electrical resistance serves, on the one hand, to prevent contact between the product that is to be placed in the container with the aluminum and, on the other hand, to prevent electrostatic charges and their associated risks, for example, the risk of explosion. The term “reduced electrical resistance” means that the plastic layer has a lower electrical resistance than the pure plastic material and, thus, has no non-conductive or isolating properties, but rather antistatic or dissipative electrical properties. Accordingly, the reduced electrical resistance of this plastic layer is customarily achieved not by using a specially selected pure plastic material, but rather by adding certain admixtures to the plastic material, whereby such admixtures are commercially available.

In the case of the plastic layers with reduced electrical resistance, a distinction is made between
dissipative plastic layers that have an electrical resistance of a maximum of 10⁸Ω across their layer thickness;
antistatic plastic layers that have an electrical resistance of between 10⁸Ω and 10¹¹Ω across their layer thickness, whereby both of the aforementioned plastic layers are unlike
non-conductive or isolating plastic layers that have an electrical resistance exceeding 10¹¹Ω across their layer thickness and, accordingly, have an electrical resistance that is typical for the plastic used or even intentionally increased by using admixtures, but, in any case, not a reduced electrical resistance.

For purposes of simplicity, the term “plastic layer with reduced electrical resistance” is hereinafter frequently shortened to “dissipative plastic layer”, even when, according to the above definition, it is, for example, merely an “antistatic” layer and not a “dissipative” plastic layer.

The connection or bond between the plastic layer with reduced electrical resistance and the aluminum layer is problematic if, as is known in the industry and customary, the dissipative plastic layer is constructed to be dissipative, or antistatic, by the emplacement of carbon components. Carbon additives hide the risk of a poor bond to the adjacent layer, so that, in some cases, the aluminum layer may become separated from the dissipative plastic layer under the stresses occurring during use or operation, such that the bond of the overall multi-layer foil, particularly in the heat seal area, may be interrupted or destroyed.

DE 44 31 046 A1 discloses a plastic packaging container with improved electrostatic dissipation, in which the side of the laminated film facing the product, which forms the container wall, has a perforation, in order to enable the charge transport of an electrical charge to an electrically conductive intermediate layer in the laminated film. Such a container is not approved for contact with foodstuffs or pharmaceuticals, because contact of foodstuffs or pharmaceuticals with the electrically conductive, metallic intermediate layer is not permitted.

DE 92 07 044 U1 discloses a transparent antistatic laminated film that is provided as stiff and hermetically sealed wrapping for electronic components. Suitability of this packaging material for foodstuffs is not intended. Antistatic laminated films are also known from EP 0 219 315 A2, DE 88 14 712 U1, and EP 0 003 402 A1.

EP 0 512 364 A1 discloses a triple-layer laminated film, in which the three layers are coextruded. A first outer layer is capable of carrying mechanical loads. A middle layer is provided as a barrier layer that is impervious to oxygen and light. A second outer layer is provided as a protection for the barrier layer, by preventing contact with the packaged product and, furthermore, to make possible that film seal with itself when the packaging is sealed. A bond or lamination to other layers is not intended in the case of this laminated film.

### BRIEF SUMMARY OF THE INVENTION

It is an object of the invention to improve a conventional film so that, on the one hand, a reliable bond of all layers is ensured under all types of operational stress and furthermore, that the overall multi-layer film may be constructed in a way that is deemed safe for foodstuffs and electrostatically, that is, has a breakdown voltage up to the aluminum layer of no more than 4 kV. Another object of the invention is to specify a production process for such a film. Finally, it is an object of the invention to create a container referred to as a big bag or FIBC that is constructed in a way that is deemed safe electrostatically and for foodstuffs.

These objects are achieved by providing a multi-layer film comprising a triple layer coextrusion film, a barrier layer bonded to the coextrusion layer, and a plastic layer of limited extensibility that is bonded to the side of the barrier layer that faces away from the coextrusion film. A dissipative plastic layer forms the middle layer of the triple-layer coextrusion film. The invention further encompasses a process of producing the multi-layer film with triple-layer coextrusion film, as well as a big bag container made of the inventive film. The inventive multi-layer film is produced by initially coextruding a triple-layer coextrusion film having a middle layer with reduced electrical resistance, a first outer layer that is made of a plastic that is easily bondable to a dissipative barrier layer and second outer layer that is foodstuffs safe. In the coextrusion process, the first outer layer is bonded to one side of the layer with reduced electrical resistance and the second outer layer bonded to the other side. The dissipative barrier layer is subsequently bonded to the first outer layer of the coextrusion film. The big bag container according to the invention has walls made of the film according to the invention.

In other words, the invention does not propose to bond or connect the antistatic or dissipative plastic layer directly to the barrier or aluminum layer, for example, by using an adhesive agent, but rather, to provide an additional layer therebetween. This additional layer may be bonded to the aluminum layer in a known manner, for example, by using an adhesive agent or the extrusion process. In the extrusion process, the aluminum layer is produced as a flat film and the film that has an additional layer is first produced as a tube and then cut open and laid flat. Shortly before the aluminum layer contacts the film with the additional layer, a liquid polymer, such as PE, is sprayed on, which, as with the adhesive agent in the other case, makes it possible to achieve a good bond of the aluminum layer with the additional layer.

According to the proposal, both this specified additional layer, as well as a layer provided on the other side of the dissipative plastic layer, and the dissipative plastic layer itself are produced as a triple-layer coextrusion film, thus reliably bonding the additional layer itself to the dissipative plastic layer. By coextruding these three layers, a heat-sealing or fusing of the individual layers occurs while they are in the liquid state. As a result, the first-mentioned additional layer that faces the aluminum layer is reliably anchored with the otherwise poorly laminable or adhesively fixable dissipative plastic layer.

In other words:
Because the dissipative plastic layer has a high ratio of dissipation-improving additives, such as, for example, carbon, it is normally poorly bondable with other layers of a multi-layer film, for example, with the dissipative barrier layer, which can, for example, be made of aluminum.
It is possible to reduce the ratio of these aforementioned additives, in order to achieve a better bond of the dissipative plastic layer to the dissipative barrier layer, but this disadvantageously results in a higher breakdown voltage of the film.
It is possible, as a first alternative, in order to reduce the breakdown voltage, to reduce the layer thickness of the entire film by having the dissipative plastic layer form an outer layer of the film and not using an additional separation layer to separate it from a product to be packaged; but then, this film is not approved for contact with foodstuffs or pharmaceuticals, since their contact with the dissipation-improving additives is to be avoided.
It is possible, as a second alternative, in order to reduce the breakdown voltage, to perforate the dissipative plastic layer, so as to make transportation of the electrical charges transported to the dissipative barrier layer easier; but, in this case, too, such a film is not approved for contact with foodstuffs or pharmaceuticals, because contact of foodstuffs or pharmaceuticals with the dissipative barrier layer, which can, for example, be made of aluminum, is to be avoided.

This problem of conflicting goals in the development of the packaging film is solved according to the proposal, by using a coextrusion process and providing the generally poorly bondable dissipative plastic layer with two outer layers, one of which enables good bonding to other layers and the other of which forms a separation layer to the product and that is deemed safe for foodstuffs. During coextrusion, surprisingly, even dissipative plastic layers, which have a high ratio of dissipation-improving additives, let themselves be reliably bonded to other layers.

Because the three layers are bonded into one overall film through coextrusion and the use of adhesive agents between the three layers can be eliminated, the breakdown voltage of this triple-layer coextrusion film is kept particularly low, so that despite the use of a relatively high number of layers overall, a multi-layer film may be created that easily meets the requirements demanded of an electrostatically dissipative multi-layer film.

When it is mentioned in the aforenamed DE 44 31 046 A1 that a coextruded film may be used for the inner layer provided therein, this reflects merely one of the many possible conventional, production-related economic uses of existing equipment. When, namely, an existing production system includes a coextruder, films that have multiple layers of identical material are also produced as coextrusion films. This type of film production is more economical than also having to provide a mono-extruder for such cases. In any case, DE 44 31 046 A1 makes no mention of producing the coextruded film with several layers of different materials and, particularly, makes no mention of constructing the coextruded film by selecting the materials of the individual layers within the coextruded film for the benefit of a reduced electrical resistance. In this respect, the perforations in the inner layer, that is, for the complete coextruded film, are provided, to allow a charge transport of electrical charges to the electrically conductive intermediate layer in the laminated film. Due to these perforations, the inner layer according to DE 44 31 046 A1 must not contain material which has a reduced electrical resistance and which is possibly poorly bondable to adjacent layers. Consequently, no problem arises as to how the inner layer may be bonded to other layers of the laminated film.

Furthermore, according to the invention, the integrity of the relatively thin aluminum layer is to be ensured by providing the side facing away from the coextrusion film with a plastic layer of limited extensibility, which allows it to bear tensile forces without causing cracks or tears in the aluminum layer.

A PET film can be used advantageously to form the plastic layer of limited extensibility, because PET, on the one hand, is easily bondable to the aluminum layer in a conventional manner and, on the other hand, is able to bear high tensile forces with only a slight extension.

Alternatively, the plastic layer of limited extensibility may be made of oriented polypropylene (OPP), whereby, however, both PET and OPP are mentioned merely as examples of materials that have been proven in practical trials.

Advantageously, the aluminum layer may be bonded to the coextrusion foil by means of an adhesive agent. This conventional bonding technique produces a reliable bond between the aluminum layer and the coextrusion foil and is made possible by providing the previously mentioned additional layer in the coextrusion foil between the dissipative plastic layer and the aluminum layer. This makes possible a reliable adhesion to the aluminum layer, which, when using an adhesive agent between the aluminum layer and the dissipative plastic layer directly, would not result in sufficient mechanical stability of the laminated film.

Advantageously, the additional layer mentioned at the beginning may be constructed as an antistatic. This avoids an impermissibly high breakdown voltage of the multi-layer film, even when the adhesive agent, which is provided between the aluminum layer and the aforementioned additional layer, does not exhibit good dissipative values. Furthermore, the aforementioned additional layer may be constructed as thin as possible, for example, a layer thickness not exceeding 10 microns, thus enabling the lowest possible breakdown voltage up to the aluminum foil.

The antistatic construction of the aforementioned additional layer may be achieved particularly by adding a permanent antistatic additive to the plastic that forms this layer, whereby this layer is advantageously made of polyethylene, which makes adherence to the aluminum layer possible, using an adhesive agent, without difficulty.

The layer provided on the opposite side of the dissipative plastic layer, that is, on the side facing away from the aluminum layer of the overall three-layer coextrusion film, can advantageously be made of polyethylene. Here, the use of the purest possible polyethylene is particularly advantageous. First of all, this material is deemed safe for foodstuffs, so that, secondly, expensive additives may be eliminated. Furthermore, the material properties of the pure polyethylene provide the film with excellent heat-sealing properties when, for example, two sections of the same film, or the respective PE surfaces of two identical films, are placed facing each other and are heat-sealed, resulting in an excellent seal seam strength.

The aforementioned multi-layer film may be used particularly to construct the walls of a packaging container, for example, the Big Bags mentioned at the outset, whereby the multi-layer film may serve advantageously in the manufacture an inliner for such a packaging container. The outer shell of such packaging containers may be made of a tear-proof fabric in the conventional manner.

The construction of the proposed film will be described in greater detail in the following paragraphs, using the example of a flexible packaging container, whereby terms such as “inner” and “outer” are used to refer to the layers of the container or layers of the laminated film that face toward the inside of the container and toward the outside of the container, respectively.

Thus, for example, a layer of the laminated film that has limited extensibility and that faces outward can have a layer thickness or strength of approximately 12 microns and be made of polyester (PET) or oriented polypropylene (OPP).

The next inside layer of the multi-layer film that is provided is the aforementioned aluminum layer, whereby aluminum is mentioned merely as an example and preferably used for economic reasons. It can also be replaced, for example, by films made of other metals, such as, gold, based on the technical demands for a layer with the greatest possible imperviousness to steam and electrically dissipation. The layer thickness of the barrier layer may be approximately 9-12 microns when an aluminum layer is used.

The multi-layer film has as its next component a coextrusion film that is bonded to the aluminum layer by means of an adhesive agent. A very thin plastic layer is provided within the three-layer coextrusion film and immediately adjacent the aluminum layer. The very thin plastic layer has a layer thickness of, for example, approximately 8 microns and is made of a plastic that may be bonded to the aluminum layer without difficulty, for example, a polyethylene, particularly a LDPE, whereby a commercially available permanent antistatic additive is mixed with this layer.

The middle layer of the coextruded film is made of, for example, a polyethylene film that is approximately 60 microns thick, for example, an LDPE, whereby it is adjusted to be antistatic or dissipative by means of a high ratio of carbon, for example, 60% or 65%.

The last layer of the three-layer coextrusion film, which is the innermost layer in the container, and thus the last layer of the overall five-layer laminated film, is made of a polyethylene that is deemed safe for foodstuffs, for example, especially an LDPE, and it has a layer strength or thickness of approximately 13 microns. This layer strength makes it possible to achieve a reliable heat seal of the multi-layer film and a breakdown voltage that is lower than 4 kV. The inner side of this innermost layer, which faces the product, is preferably free of perforations, indentations, etc., so that, advantageously and in the interest of good hygiene, the possibility is excluded of either a very fine, for example, dust-like, product coming into contact with the container material, from which it should really be separated by the innermost layer, or residues of this product being able to settle in the perforations or indentations.

The two outer layers of the overall three-layer coextrusion film can also be switched, whereby, however, the innermost layer, that is, the layer facing the product, then contains the antistatic additive and must be provided with a relatively greater layer strength, in order to guarantee sufficiently strong seal seam. In contrast, the proposed layer construction, or the proposed layer order of the three-layer coextrusion film, is more advantageous with respect to cost.

The outermost limited extensibility layer, for example, the previously mentioned PET layer, is advantageously constructed made to be narrower on two opposing edges of the film with respect to the overall dimensions of the film, so that there the aluminum layer and the other layers of the laminated film extend beyond the width of the plastic layer of limited extensibility. In this way, the aluminum layer is exposed in the area of the outermost edges of the laminated film, for example, a width of approximately 10 mm, so that it may be grounded without difficulty or electrically conductingly connected to the outer fabric of a Big Bag, so that the entire packaging container may be grounded without difficulty.

### BRIEF DESCRIPTION OF THE DRAWINGS

An embodiment of the invention is discussed below in more detail using the strictly schematic drawing:

FIG. 1 shows generally a schematic cross-section through the individual layers or strata of an overall five-layer film, whereby, for the sake of clarity, the individual layers or strata are shown separated from one another and additives, for example, adhesive agents, are not shown.

### DETAILED DESCRIPTION OF THE INVENTION

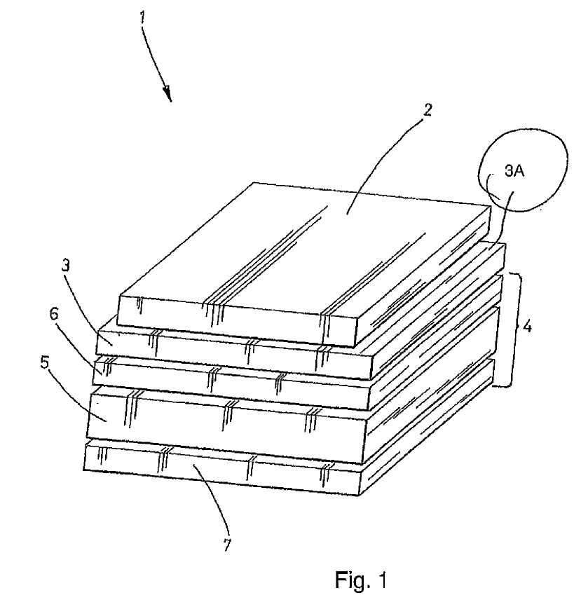

FIG. 1 shows a multi-layer film according to the invention. The entire multi-layer film is indicated in general by the number 1. The film has a plastic layer of limited extensibility 2 made of PET, with a layer strength of 12 microns. The layer of limited extensibility 2 is constructed narrower than all of the layers or strata of film 1 shown below it, leaving an exposed edge 3A on both sides of the multi-layer film 1.

The plastic layer of limited extensibility 2 is bonded to an aluminum layer 3 shown below it. The aluminum layer 3 a layer thickness or strength of 9 microns. The layers 2 and 3 are bonded together, for example, by means of adhesive agents or in an extrusion process. The aluminum layer 3 is bonded to a triple-layer coextrusion film 4, for example, likewise by means of adhesive agents or in an extrusion process.

The coextrusion film 4 is made of an intermediate antistatic or dissipative polyethylene film 5 having a layer thickness of 59 microns, as well as a layer 6 made of LDPE, which faces the aluminum layer 3 and which is enhanced with a permanent antistatic additive.

The innermost layer 7 that faces the product has a layer thickness of 13 microns and is made of a polyethylene that is deemed safe for foodstuffs, namely, LDPE. This layer comes into contact with the filling of the packaging material that is later produced from the multi-layer film 1.

1. Multi-layer film comprising:
a coextrusion film having three coextruded layers that include a middle layer that is a plastic layer with reduced electrical resistance, a first outer layer, and a second outer layer;
a dissipative barrier layer having a first side that faces toward said coextrusion film and a second side that faces away from said coextrusion film; and
a plastic layer of limited extensibility;
wherein said first side of said dissipative barrier layer is bonded with said first layer of said coextrusion film and said second side is bonded with said plastic layer of limited extensibility.

2-10. (canceled)

11. Packaging container made of a flexible material, said packaging container comprising a wall that is made of a multi-layer film that comprises a coextrusion film having three coextruded layers that include a middle layer that is a plastic layer of reduced electrical resistance, a first outer layer, and a second outer layer, a dissipative barrier layer having a first side that faces toward said coextrusion film and a second side that faces away from said coextrusion film, and a plastic layer with limited extensibility;
wherein said first side of said dissipative barrier layer is bonded with said first layer of said coextrusion film and said second side of said dissipative barrier layer is bonded with said plastic layer of limited extensibility.

12-18. (canceled)

19. Process for producing a multi-layer film that includes a dissipative barrier layer and a triple-layer coextrusion film, said process comprising the steps of:
(a) initially producing said triple-layer coextrusion film having three coextruded layers that include a first outer layer and a second outer layer, with a middle layer therebetween, said middle layer having reduced electrical resistance, said first outer layer comprising a plastic that is readily bondable to said dissipative barrier layer, and said second outer layer comprising a material that is foodstuffs safe; and
(b) bonding said first outer layer with said dissipative barrier layer.

20. Container designated as Big Bag or FIBC, said container comprising a container wall that includes a multi-layer film that comprises a coextrusion film having three coextruded layers that include a middle layer, a first outer layer, and a second outer layer, a dissipative barrier layer having a first side that faces toward said coextrusion film and a second side that faces away from said coextrusion film, and a plastic layer with limited extensibility;
wherein said first side of said dissipative barrier layer is bonded to said first layer of said coextrusion film and said second side is bonded with said plastic layer of limited extensibility.

21. (canceled)

22. The multi-layer film of claim 1, wherein said plastic layer of limited extensibility is formed of a polyester (PET) material.

23. The multi-layer film of claim 1, wherein said dissipative barrier layer is bonded to said coextrusion film by means of an adhesive agent.

24. The multi-layer film of claim 1, wherein said dissipative barrier layer is bonded to said coextrusion film in an extrusion process.

25. The multi-layer film of claim 1, wherein said first outer layer of said coextrusion film is adjacent said dissipative barrier layer and is an antistatic layer.

26. The multi-layer film of claim 25, wherein said antistatic layer includes a permanent antistatic additive.

27. The multi-layer film of claim 25, wherein said first outer layer is made of polyethylene (PE).

28. The multi-layer film of claim 1, wherein said first outer layer has a thickness of maximum 10 microns.

29. The multi-layer film of claim 1, wherein said second outer layer of said coextrusion film is made of polyethylene.

30. The multi-layer film of claim 1, wherein said dissipative barrier layer is an aluminum layer.

31. The packaging container of claim 11, wherein said wall has an inliner and said multi-layer film forms said inliner.

32. The multi-layer film of claim 1, wherein said layer with reduced electrical resistance has a carbon ratio of 30% to 80%.

33. The multi-layer film of claim 1, wherein said plastic layer with reduced electrical resistance is made of polyethylene.

34. The multi-layer film of claim 1, wherein said plastic layer with reduced electrical resistance is an antistatic layer.

35. The multi-layer film of claim 1, wherein said plastic layer with reduced electrical resistance is a dissipative layer.

36. The multi-layer film of claim 1, wherein said coextrusion film and said dissipative barrier layer have a first film dimension that defines a first width and said plastic layer of limited extensibility has a second film dimension that defines a width that is narrower than said first film dimension, such that, when said plastic layer of limited extensibility is placed over said dissipative barrier layer, two edges along said dissipative barrier layer remain uncovered by said plastic layer of limited extensibility.

37. The process of claim 19 further comprising the step of:
(c) bonding a plastic layer of limited extensibility to a second side of said dissipative barrier layer.

38. Container designated as Big Bag or FIBC, said container comprising a container wall that consists of a multi-layer film that is constructed from a coextrusion film having three coextruded layers that include, a first outer layer, a second outer layer, and a middle layer therebetween that is a plastic layer with reduced electrical resistance, a dissipative barrier layer having a first side that faces toward said coextrusion film and a second side that faces away from said coextrusion film, and a plastic layer of limited extensibility;
wherein said first side of said dissipative barrier layer is bonded to said first layer of said coextrusion film and said second side of said dissipative barrier layer is bonded with said plastic layer of limited extensibility, and
wherein said coextrusion film and said dissipative barrier layer have a first film dimension that defines a first width and said plastic layer of limited extensibility has a second film dimension that defines a width that is narrower than said first film dimension, such that, when said plastic layer of limited extensibility is placed over said dissipative barrier layer, two edges along said dissipative barrier layer remain uncovered by said plastic layer of limited extensibility.
